(19) United States
(12) Patent Application Publication
(10) Pub. No.: US 2025/0083648 A1
(43) Pub. Date: Mar. 13, 2025

(54) METHOD AND DEVICE FOR SAFELY BRAKING A TRAILER

(71) Applicant: ZF CV Systems Global GmbH, Bern (CH)

(72) Inventor: Julian van Thiel, Grossburgwedel (DE)

(21) Appl. No.: 18/957,280

(22) Filed: Nov. 22, 2024

Related U.S. Application Data
(63) Continuation of application No. PCT/EP2023/063206, filed on May 17, 2023.

(30) Foreign Application Priority Data
Jun. 7, 2022 (DE) 10 2022 114 280.9

(51) Int. Cl. B60T 7/20; B60T 13/26; B60T 13/66; B60T 13/68

(52) U.S. Cl. CPC B60T 7/20; B60T 13/26; B60T 13/662; B60T 13/683

(57) ABSTRACT

A method is for safely braking a trailer of a vehicle combination including a motor vehicle and the trailer. The motor vehicle has an electronically controllable pneumatic motor vehicle braking system and the trailer has a pneumatic trailer braking system. The motor vehicle braking system and the trailer braking system are connected at least by a trailer control line and a trailer feed line. The trailer braking system has at least one trailer brake circuit including a trailer supply reservoir for making available a trailer supply pressure for the trailer brake circuit, service brake actuators and spring brake actuators. In response to a demand for safe braking of the trailer, the motor vehicle brings about lowering of the trailer supply pressure in the trailer brake circuit, with the result that the spring brake actuators of the trailer are applied and safely brake the trailer.

### CROSS-REFERENCE TO RELATED APPLICATIONS

This application is a continuation application of international patent application PCT/EP2023/063206, filed May 17, 2023, designating the United States and claiming priority from German application 10 2022 114 280.9, filed Jun. 7, 2022, and the entire content of both applications is incorporated herein by reference.

### TECHNICAL FIELD

The disclosure relates to a method for safely braking a trailer of a vehicle combination including a motor vehicle and a trailer, wherein the motor vehicle has an electronically controllable pneumatic motor vehicle braking system and the trailer has a pneumatic trailer braking system, wherein the motor vehicle braking system and the trailer braking system are connected at least by a trailer control line and a trailer feed line, and the trailer braking system has at least one trailer brake circuit including a trailer supply reservoir for making available a trailer supply pressure for the trailer brake circuit, service brake actuators and spring brake actuators. The disclosure furthermore relates to an electronically controllable pneumatic motor vehicle braking system for a motor vehicle of a vehicle combination and to a motor vehicle having an electronically controllable pneumatic motor vehicle braking system.

### BACKGROUND

The method, motor vehicle braking system and motor vehicle presented here are directed to an application in which the motor vehicle has an electronically controllable pneumatic braking system and the trailer has, in particular, a purely pneumatic trailer braking system including an electrified parking brake. When trailers of a vehicle combination are parked, the trailers must be secured. This is generally accomplished via a dual safeguard, namely, on the one hand, either by applying spring brake actuators of the trailer or actuating the service brake of the trailer, and manual securing via chocks, which are placed manually against the wheels of the trailer in order to prevent the trailer from rolling away. Typically, trailers are configured in such a way that either a parking brake signal can be provided, for example, by a driver in the motor vehicle, this then bringing about the application of the spring brake actuators in the trailer, or the feed line between the motor vehicle and the trailer is merely released, as a result of which, in turn, a pneumatic circuit is actuated, which in this case either vents the spring brake actuators or alternatively supplies air to service brake actuators of the trailer in order to immobilize the trailer in this way. If the trailer then has to be maneuvered in a yard, for example, trailers typically have a manual switch, via which the operator can release the spring brake actuators or service brake actuators on the trailer itself in order then to maneuver the trailer. The manually provided chocks provide additional security in the event that the spring brake actuators or service brake actuators of the trailer are unintentionally released, for example, by actuation of the manual switch on the trailer.

DE 10 2015 119 135 A1 discloses a pneumatic braking device for a commercial vehicle. The pneumatic braking device has at least one pneumatically controllable spring brake actuator for a parking brake of the commercial vehicle and an electronic parking brake device having at least one electronic control system, at least one bistable valve unit, at least one first valve unit, via which a parking brake of the trailer of the commercial vehicle can be deactivated when the parking brake of the commercial vehicle is activated, and at least one second valve device, which can be interconnected in such a way that, when the system pressure for feeding the parking brake of the trailer is lowered, the parking brake of the trailer can be activated. This second valve device can, for example, have a pressure sensor, via which a pressure drop in the system pressure for the parking brake of the trailer below a predetermined threshold value can be determined and a signal can be generated, on the basis of which the parking brake of the trailer is activated via the electronic control system. DE 10 2015 119 135 A1 thus envisages generating a signal when the system pressure falls, for example, on account of a prolonged standing time or a fault, and then activating the parking brake of the trailer and applying it in order to prevent unwanted rolling away of the trailer if the system pressure rises again. However, it is not possible in this way to eliminate the problem that the switch for releasing the parking brake of the trailer may be actuated unintentionally.

DE 10 2017 118 529 A1 furthermore discloses an electronically controlled trailer brake control unit for a trailer of a commercial vehicle. Both a modulator valve device, which can be configured as an EBS control unit, and a spring brake valve device are integrated into the trailer brake control unit. Via the spring brake valve device, spring brake functions such as a parking function, a release function, an override function, a spring brake immobilization function, an unregulated emergency braking function, a regulated spring brake emergency braking function, a reservoir-controlled spring brake function, an automatic parking brake actuation function, an auxiliary braking function, an anti-jackknife braking function, a test function or an emergency braking prevention function can be provided. In a manner similar to that already described with reference to DE 10 2015 119 135 A1, the emergency braking function includes a functionality with which emergency braking can be initiated automatically if the pressure at the coupling head supply or in the feed line drops.

### SUMMARY

It is an object of the present disclosure to improve the securing of the trailer when stationary and, in particular, to avoid unintentional rolling away of the trailer.

The disclosure achieves the object in the case of a method by virtue of the fact that, in response to a demand for safe braking of the trailer, the motor vehicle brings about lowering of the trailer supply pressure in the trailer brake circuit, with the result that the spring brake actuators of the trailer are applied and safely brake the trailer.

In contradistinction to what is known in the prior art, the disclosure uses deliberate lowering of the trailer supply pressure in the trailer brake circuit to thereby enable the spring brake actuators to be applied. Spring brake actuators are constructed in such a way that they are applied on the basis of a spring force and have a pressure chamber which can be supplied with compressed air in order to release the brake pads counter to the spring force. That is, that the spring brake actuators are applied when unpressurized, while they open when air is admitted under pressure. The disclosure makes use of this fact and deliberately lowers the trailer supply pressure in order to exploit the application of the spring brake actuators. If the trailer is parked in this state, no pressure is output, even if the release switch on the trailer itself is accidentally actuated, and spring brake actuators cannot be released even in that case. As a result, it may be sufficient under certain circumstances to park the trailer in this state without providing additional chocks at the wheels. Thus, according to the disclosure, it is not merely that the parking brake of the trailer is applied via a valve circuit and spring brake actuators are vented but that the system pressure of the trailer is lowered in such a way that spring brake actuators are applied irrespective of the switching positions of valves. It is thereby possible to increase the security of the parked trailer against rolling away.

According to the disclosure, the demand for safe braking is output by the motor vehicle itself. This includes a scenario where this demand for safe braking is supplied manually by a driver in the cockpit by actuating a corresponding switch, for example, or automatically by a unit for autonomous driving. It can also be supplied, for example, by an electronic air treatment unit or other systems in the motor vehicle. As a particular preference, the motor vehicle braking system supplies the demand for safe braking of the trailer when, for example, the motor vehicle braking system detects that the vehicle combination as a whole is to be parked, or is requested to do this. It is also conceivable and preferred that the demand for safe braking be supplied in an emergency by a backup unit, preferably a backup unit of the motor vehicle braking system. If, for example, normal brake actuation of the trailer is not possible or can no longer be correctly implemented, the demand according to the disclosure for safe braking can be supplied and, as a result, the trailer supply pressure in the trailer brake circuit can be lowered in order in this way to bring about application of the spring brake actuators and to safely brake the trailer.

The trailer supply pressure is preferably lowered to a value below a minimum pressure, preferably the release pressure of the spring brake actuators, in the trailer. The minimum pressure can be 1 bar or less, for example. Other minimum values are also conceivable but these should in each case be chosen so that reliable application of the spring brake actuators takes place.

The trailer braking system can be of purely pneumatic configuration, for example, in the form of an ABS system, or can also be electronically controllable. In the latter case, an electronic connection (ISO BUS) is generally provided between the motor vehicle braking system and the trailer braking system, via which signals can likewise be transmitted.

In an embodiment, the method includes the step of: preventing pressure output via the trailer feed line to prevent filling of the trailer supply reservoir. It is thereby possible to maintain the safely braked state of the trailer even if, for example, a compressed air treatment unit in the motor vehicle delivers compressed air. Prevention preferably takes place before the lowering of the trailer supply pressure in the trailer brake circuit in order to avoid delivery being performed during the lowering process as well.

To prevent pressure being output via the trailer feed line, it is possible in a first variant to divide the trailer feed line to prevent filling of the trailer supply reservoir. For this purpose, a driver of the vehicle train can manually decouple the feed line, for example. However, it is also preferred that an automated coupling system be provided, which automatically carries out the division of the trailer feed line in this case.

In another variant, it is envisaged that prevention of pressure output via the trailer feed line is implemented by deactivating compressed air delivery via the trailer feed line. For this purpose, a compressor can be deactivated, for example, thus preventing refilling of the trailer supply reservoir. The motor vehicle braking system preferably deactivates compressed air delivery to a trailer brake circuit on the motor vehicle side or to the compressed air supply in the motor vehicle that feeds the trailer feed line with compressed air. In order to feed the trailer supply reservoir, a separate supply reservoir is typically provided in the motor vehicle, and this can be shut off for this purpose, for example. If a separate compressor is provided for the trailer in the motor vehicle, it may be sufficient to deactivate this compressor. Pressure output should be prevented or reduced in such a way that the volume flow consumed in the trailer exceeds, preferably significantly exceeds, the replacement volume flow that is being delivered.

In another variant, prevention of pressure output via the trailer feed line can be brought about by causing at least one valve assembly to switch in order to shut off, vent and/or restrict the trailer feed line. The switching of the valve assembly is preferably brought about by the motor vehicle braking system. Pressure output for filling the trailer supply reservoir can also be prevented by restriction since, in a restricted state, only a small amount of air is delivered, and this is not sufficient to fill the trailer supply reservoir.

In a further embodiment, the valve assembly which is caused to switch is a breakaway safety valve of the motor vehicle braking system. Breakaway safety valves of this kind are typically provided in motor vehicle braking systems, for example, in a so-called trailer control valve or trailer control module. Breakaway safety valves are configured in such a way that if the trailer feed line breaks away, they are pneumatically triggered so as to switch, and block or at least restrict the connection between the corresponding coupling head and the supply on the motor vehicle side. According to the embodiment proposed here, however, the switching of the breakaway safety valve is triggered or demanded by the motor vehicle braking system itself in order in this way to prevent further pressure output to the trailer. In this case, it is not necessary to decouple the trailer feed line since pressure output is also prevented by the switching of the breakaway safety valve, and the spring brake actuators of the trailer remain safely applied.

In a further embodiment, the breakaway safety valve is pneumatically switchable, and the motor vehicle braking system outputs a breakaway control pressure at the breakaway safety valve in such a way that the latter switches and prevents pressure output via the trailer feed line. The pneumatic switching of the breakaway safety valve is a particularly simple possibility since such valves typically have pneumatic return and self-locking and therefore generally have a pneumatic control port.

According to various embodiments, it is furthermore preferred that the valve assembly includes an electromagnetic deactivation valve unit, which can be controlled by the motor vehicle. The electromagnetic deactivation valve unit is preferably controllable by the motor vehicle braking system. The electromagnetic deactivation valve unit can, for example, directly shut off or restrict the trailer feed line, or alternatively it can also make available the breakaway control pressure for the breakaway safety valve. For this purpose, the electromagnetic deactivation valve unit can receive a supply pressure or some other working pressure from a pressure circuit provided in the motor vehicle, for example, a compressed air supply reservoir, which is not provided for the trailer or is in some other system.

According to various embodiments, it is furthermore preferred that the electromagnetic deactivation valve unit is connected pneumatically upstream and/or downstream of a trailer control valve of the motor vehicle braking system. The electromagnetic deactivation valve unit can be connected pneumatically upstream of the trailer control valve, for example, by connecting the electromagnetic deactivation valve unit between a compressed air supply provided for the trailer control valve and the corresponding supply port provided on the trailer control valve. Switching the electromagnetic deactivation valve unit enables this unit to interrupt the connection between the compressed air supply reservoir and the supply port on the trailer control valve and thus prevent compressed air being output from the trailer control valve to the trailer. On the other hand, the electromagnetic deactivation valve unit can also be connected downstream of the trailer control valve of the motor vehicle braking system by arranging the latter between a corresponding port of the trailer control valve and the coupling head for connecting the trailer feed line and thus enabling it to interrupt this connection.

According to various embodiments, as a further preference, the valve assembly can include an electromagnetic trailer vent valve in the trailer braking system, which can be controlled by the motor vehicle. A trailer vent valve of this kind can be arranged on the trailer supply reservoir in such a way, for example, that the latter can be vented directly to the surroundings.

In another embodiment of the method, the lowering of the trailer supply pressure includes actuating the service brake actuators of the trailer braking system. It is thereby possible, on the one hand, to achieve a more rapid halt of the trailer since service brake actuators can typically respond somewhat more quickly than spring brake actuators but, at the same time, the air consumption in the trailer is also increased, and therefore the lowering of the trailer supply pressure can take place quickly. The service brake actuators of the trailer braking system are preferably actuated in such a way that a high air consumption is achieved.

For example, the actuation of the service brake actuators takes place in a pulsed manner, namely by alternate air admission to and venting of the service brake actuators. If air is admitted, vented and readmitted to the service brake actuators quickly in succession, the air consumption is particularly high, and the lowering of the trailer supply pressure takes place particularly quickly. By this means too, particularly quick braking of the trailer can be achieved.

In another embodiment, the lowering of the trailer supply pressure includes actuating a trailer parking brake. The trailer parking brake is first of all preferably actuated by venting the spring brake actuators and then actuating the service brakes in a pulsed manner. If the trailer has an anti-compound circuit, actuation of the service brakes will lead to simultaneous air admission to and thus release of the spring brake actuators in order to prevent overloading of the actuators. If the service brake actuators are actually pulsed in this case, a particularly high air consumption is achieved, thus enabling the lowering of the trailer supply pressure to take place particularly quickly.

According to various embodiments, it is furthermore preferred that the lowering of the trailer supply pressure includes actuating an alternative air consumer in the trailer, preferably a level control system and/or lift axle. The actuation of the alternative air consumer in the trailer is preferably demanded by the motor vehicle braking system, for example, via the trailer BUS. It is preferred that the demand for safe braking is provided by the motor vehicle. The demand for safe braking is preferably initiated by the motor vehicle braking system, and particularly preferably by a subsystem of the motor vehicle braking system, for example, a service brake system, a parking brake system, an electronic air treatment unit and/or a unit for autonomous driving of the motor vehicle. It is also conceivable that a plurality of these systems can provide the demand for safe braking, depending on availability and the event that triggers the demand. If, for example, the vehicle train as a whole is set aside and parked, there may be a preference for the demand to be provided by the parking brake system of the motor vehicle braking system. If, on the other hand, it is a matter of emergency braking in the event of a fault, there may be a preference for a unit for autonomous driving of the motor vehicle to provide this signal.

According to various embodiments, it is further preferred that conclusion of the lowering of the trailer supply is followed by driving the motor vehicle against the safely braked trailer to test the braking effect. For this purpose, provision can be made for the system that has also provided the demand for safe braking to provide a signal for driving the motor vehicle into contact. It is sufficient here if only a very small force or torque is applied to test rolling of the trailer. Decoupling and safe parking of the trailer can then take place.

In a second aspect, the disclosure achieves the object stated at the outset, in the case of an electronically controllable pneumatic motor vehicle braking system, stated at the outset, for a motor vehicle of a vehicle combination in that the combination has: a service brake system having a trailer control valve with a trailer feed port for connecting a trailer feed line, and a trailer brake pressure port for connecting a trailer control line, and at least one trailer brake circuit on the motor vehicle side for supplying the trailer control valve with supply pressure, wherein the trailer control valve makes available a trailer supply pressure at the trailer feed port; and a primary brake control unit for controlling the service brake system, wherein the primary brake control unit is connected to a unit for autonomous driving and receives braking demand signals from the latter, wherein the motor vehicle braking system is configured, in response to a demand for safe braking of a trailer connected to the motor vehicle, to bring about a reduction in the trailer supply pressure, with the result that spring brake actuators of the trailer are applied and safely brake the trailer.

It should be understood that the method according to the first aspect of the disclosure and the electronically controllable pneumatic motor vehicle braking system according to the second aspect have identical and similar sub-aspects. Thus, it is preferred that the motor vehicle braking system is configured to carry out a method according to one of the above-described embodiments of a method according to the first aspect of the disclosure.

The motor vehicle braking system preferably includes at least one valve assembly for shutting off the trailer feed port. In an embodiment, the valve assembly includes a breakaway safety valve. The breakaway safety valve is preferably pneumatically switchable, and the motor vehicle braking system preferably has an electromagnetic trip valve unit, for outputting a breakaway control pressure at the breakaway safety valve in such a way that the latter switches and prevents pressure output via the trailer feed line.

In a further embodiment of the motor vehicle braking system, the trip valve unit is integrated into the trailer control valve or is arranged adjacent to the latter. The integration of the trip valve unit into the trailer control valve has advantages in terms of installation space, while adjacent arrangement, preferably flange-mounted arrangement of the trip valve unit on the trailer control valve, is easy to implement and can also be configured to allow retrofitting.

According to various embodiments, the valve assembly preferably includes an electromagnetic deactivation valve unit, which can be controlled by the motor vehicle braking system, preferably the primary brake control unit. The electromagnetic deactivation valve unit is connected pneumatically upstream and/or downstream of the trailer control valve. It can also be controllable by a secondary brake control unit or some other electronic control unit of the motor vehicle.

In a further embodiment, to lower the trailer supply pressure, a trailer brake pressure is output at the trailer brake pressure port of the trailer control valve. Via the trailer brake pressure, actuation of the service brake actuators of the trailer is demanded, ensuring that air consumption in the trailer is high and lowering of the trailer supply pressure can take place quickly.

In a third aspect, the disclosure achieves the object stated at the outset via a motor vehicle of the type stated at the outset, in particular a commercial vehicle, by virtue of the fact that the vehicle has an electronically controllable pneumatic motor vehicle braking system according to one of the above-described embodiments of a motor vehicle braking system according to the second aspect of the disclosure, and a unit for autonomous driving.

### BRIEF DESCRIPTION OF DRAWINGS

The invention will now be described with reference to the drawings wherein:

FIG. 1 shows a layout of a vehicle combination in a first embodiment;

FIG. 2 shows a schematic illustration of a valve assembly in a first embodiment;

FIG. 3 shows a schematic illustration of a valve assembly in a second embodiment;

FIG. 4 shows a layout of a vehicle combination in a second embodiment; and,

FIG. 5 shows a layout of a vehicle combination in a third embodiment.

### DETAILED DESCRIPTION

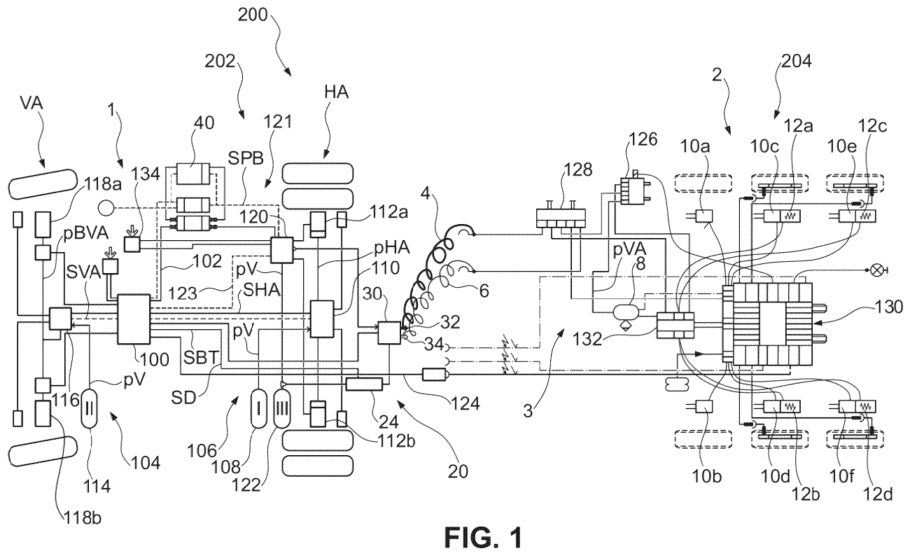

FIG. 1 first of all illustrates a vehicle combination 200 including a motor vehicle 202 and a trailer 204. The motor vehicle 202 has a motor vehicle braking system 1 and the trailer 204 has a trailer braking system 2. The motor vehicle braking system 1 is configured as an electronically controllable pneumatic braking system. In a fundamentally known manner, it has a primary brake control unit 100, which is connected via a vehicle BUS 102 to a unit for autonomous driving 40 and receives braking demand signals SBA from the latter. The primary brake control unit 100 then provides front axle brake signals SVA at a front axle VA of the motor vehicle 202 and rear axle brake signals SHA at a rear axle HA of the motor vehicle 202. A front axle brake circuit 104 is provided at the front axle VA, and a rear axle brake circuit 106 is provided at the rear axle HA. The rear axle brake circuit 106 is fed via a first compressed air supply 108 and supplied with supply pressure pV. Also provided is a rear axle modulator 110, which receives the supply pressure pV from the first compressed air supply 108 and outputs a rear axle brake pressure pBHA to first and second rear axle brake actuators 112a, 112b in accordance with the rear axle brake signals SHA received. In the same way, the front axle brake circuit 104 is supplied by a second compressed air supply 114, which likewise makes available supply pressure pV. A front axle modulator 116 is furthermore provided at the front axle VA, receiving the supply pressure pV and making available a front axle brake pressure pBVA at the first and second front axle brake actuators 118a, 118b in accordance with the front axle brake signals SVA.

The primary brake control unit 100, the rear axle modulator 110 and the front axle modulator 116, together with the first and the second compressed air supplies 108, 114, form the service brake system of the motor vehicle braking system 1.

In addition, the motor vehicle braking system 1 includes a parking brake module 120, which receives supply pressure pV from a third compressed air supply 122. The parking brake module 120 belongs to a parking brake system 121 and is connected via the vehicle BUS 102 to a/the unit for autonomous driving 40 and via an internal BUS 123 to the primary brake control unit 100. The parking brake module 120 includes its own intelligence and, in the motor vehicle braking system 1 shown here, also acts as a secondary brake control unit, which can partially replace the primary brake control unit 100 in the event of a fault.

Finally, a trailer control valve 30 is provided which, on the one hand, receives supply pressure pV from the third compressed air supply 122 and, on the other hand, receives trailer brake signals SBT from the primary brake control unit 100. In the embodiment shown here, the trailer control valve 30 does not have its own intelligence but, in other embodiments, the trailer control valve 30 may also be provided with its own intelligence.

The trailer control valve 30 is connected in a known manner to a trailer feed port 32 and a trailer brake pressure port 34, to which a trailer feed line 4 and a trailer control line 6 can be connected in a manner that is likewise known. The trailer feed port 32 can also be configured as a red coupling head or can be connected thereto, and the trailer brake pressure port 34 can also be configured as a yellow coupling head or can be connected thereto.

Supply pressure is made available to the trailer 2 via the trailer feed port 32, and a pneumatic control pressure for actuating service brakes of the trailer 2 is made available to the trailer 2 via the trailer brake pressure port 34. In the embodiment shown in FIG. 1, the motor vehicle braking system 1 also includes a trailer BUS 124, via which signals can likewise be provided. Via the trailer BUS 124, it is possible, in particular, to directly switch valves in the trailer or to transmit other signals. However, the disclosure is not limited to this and it is likewise possible to use purely pneumatic trailers, which are controlled exclusively via the trailer feed line 4 and the trailer control line 6.

In FIG. 1, the trailer braking system 2 is likewise shown purely by way of example. The trailer braking system 2 has a trailer brake circuit 3 and a trailer supply reservoir 8, in which compressed air is prestored. The trailer supply reservoir 8 is fed from the motor vehicle braking system 1 via the trailer control valve 30. For this purpose, the trailer supply reservoir 8 is connected via a protection valve 126 and a fundamentally known so-called park-release safety valve 128 to the trailer feed line 4. The trailer control line 6 is then likewise connected via the park-release safety valve 128 directly to a trailer control unit and a trailer parking brake module 132. Via the trailer control unit 130 and the trailer parking brake module 132, service brake actuators 10a-10f of the trailer braking system 2 and spring brake actuators 12a-12d are controlled in a known manner.

When the trailer 204 is to be parked in the prior art, the parking brake of the trailer 204 is then actuated, for example, by the trailer parking brake module 132 venting the spring brake actuators 12a-12d. A vehicle driver can then vent and thus release the spring brake actuators 12a-12d via the park-release safety valve 128 in order to maneuver the trailer 204. To secure against unintentional rolling away, chocks are generally laid against the wheels of the trailer in order to secure them mechanically.

During driving operation of the trailer 204, the spring brake actuators 12a-12d are vented and released.

In the context of the method for safely braking the trailer 204, the disclosure now envisages that, in response to a demand SPB for safe braking of the trailer 204, the motor vehicle 202 brings about lowering of the trailer supply pressure pVA in the trailer brake circuit 3. A drop in the trailer supply pressure pVA in the trailer brake circuit 3 then automatically leads to the spring brake actuators 12a-12d of the trailer 204 being applied and in this way safely braking the trailer 204. Since the trailer supply pressure pVA is systemically lowered, no further pressure can be output into the spring brake actuators 12a-12f to release these, even if the park-release safety valve 128 is actuated. The trailer 204 is reliably prevented from rolling away.

The demand SPB for safe braking can be provided, for example, by the unit for autonomous driving 40 via the vehicle BUS 102 and received and implemented by the primary brake control unit 100. It is also conceivable and preferred that the demand SPB is provided via a parking brake switch 134 of the motor vehicle braking system 1, for example, on the parking brake module 120, which then implements the demand SPB and either directly brings about the lowering of the trailer supply pressure pVA or first of all provides a corresponding signal to the primary brake control unit 100, which then, in turn, controls the trailer control valve 30 accordingly or brings about lowering of the trailer supply pressure pVA in some other way.

To achieve this, on the one hand, the trailer supply reservoir 8 is vented and, on the other hand, further delivery of supply pressure pV from the motor vehicle 202 to the trailer 204 is prevented. The venting of the trailer supply reservoir 8 can occur either directly, by means, for example, of a vent valve which is provided directly on the trailer supply reservoir 8 and which is separately switched, or by using consumers in the trailer 204, as described in detail below.

The use of consumers in the trailer 204 to empty the compressed air supply present in the trailer supply reservoir 8 is preferred since no further modifications then have to be made to the trailer 204 itself, and a motor vehicle 202 that is equipped with the corresponding motor vehicle braking system 1 can thus also operate and safely park otherwise unmodified conventional trailers 204 in the manner described herein.

Prevention of the further delivery of compressed air from the motor vehicle 202 to the trailer 204 can be accomplished, for example, by switching off an electronic air treatment unit (not shown in FIG. 1), which feeds the third compressed air supply 122. In the embodiment shown here (FIG. 1), the third compressed air supply 122 is responsible for supplying compressed air to the trailer 204. If the third supply 122 is no longer filled with compressed air by an air treatment unit, the trailer supply reservoir 8 is also not filled up again with compressed air. As an alternative, the vehicle driver can also release the trailer feed line 4 manually or via an automated decoupling device, such that further delivery of compressed air from the third supply reservoir 122 to the trailer 204 is also prevented in this way.

In the embodiment shown in FIG. 1, the motor vehicle braking system 1 includes a valve assembly 20 which can be switched to shut off, vent and/or restrict the trailer feed line 4. In the embodiment shown in FIG. 1, the valve assembly 20 includes an electromagnetic deactivation valve unit 24, which can be switched in order to deactivate the pressure output via the trailer feed line 4. More specifically, the deactivation valve unit 24 in the embodiment shown in FIG. 1 is connected between the third compressed air supply 122 and the trailer control valve 30, to be more precise between the third compressed air supply 122 and a supply port of the trailer control valve 30. Deactivation valve unit 24 is therefore connected upstream or pneumatically ahead of the trailer control valve 30. For this purpose, the electromagnetic deactivation valve unit 24 can, for example, have a 2/2-way valve or 3/2-way valve, which, in a first switching position, establishes the pneumatic connection between the third compressed air supply 122 and the trailer control valve 30 and, in a second switching position, divides the connection between the third compressed air supply 122 and the trailer control valve 30 and preferably vents the supply port of the trailer control valve 30. For this purpose, the electromagnetic deactivation valve unit 24 in the embodiment shown in FIG. 1 is connected to the primary brake control unit 100 and receives a deactivation switching signal SD from the latter. The deactivation switching signal SD is output by the primary brake control unit 100 in response to the receipt of the demand SPB for safe braking of the trailer 204. In other embodiments, the deactivation valve unit 24 can also be connected to additional electric control units, or may also receive the deactivation switching signal directly from the unit for autonomous driving 40.

If the deactivation switching valve 24 is moved into a switching position such that the third compressed air supply 122 is not connected pneumatically to the trailer control valve 30, compressed air delivery cannot take place via the trailer feed line 4, and as soon as the pressure in the trailer supply reservoir 8 has fallen below a minimum pressure, preferably the release pressure of the spring brake actuators 12a-12f, these are applied and cannot be released again as long as the deactivation valve unit 24 is dividing the third compressed air reservoir 122 and the trailer control valve 30.

Alternatively or in addition, provision may also be made for compressed air delivery via the trailer feed line 4 to be prevented directly in or at the trailer control valve 30.

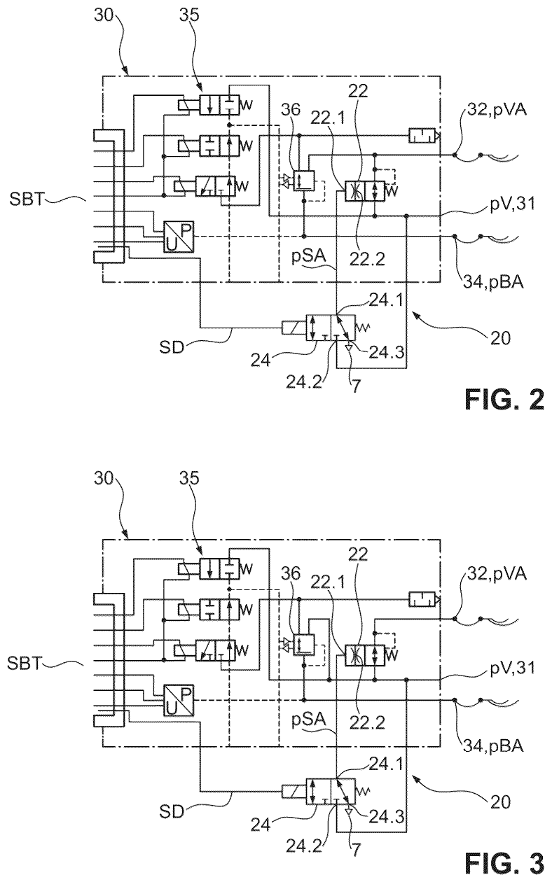

FIGS. 2 and 3 show further embodiments for this purpose. FIGS. 2 and 3 each show a schematic circuit diagram of a trailer control valve 30. As normal, the trailer control valve 30 (cf. FIG. 2) has a supply port 31, at which the supply pressure pV is made available, for example, from the third compressed air supply 122 (FIG. 1), a trailer feed port 32 for outputting trailer supply pressure pVA, and a trailer brake pressure port 34 for making available a trailer brake pressure pBA. In the interior, the trailer control valve 30 has, in a known manner, a pilot control unit 35 and a relay valve 36 in order to implement the trailer brake signals SBT and to output the trailer brake pressure pBA in conformity with the trailer brake signals SBT.

In a manner that is fundamentally likewise known, the trailer control valve 30 has a breakaway safety valve 22, which here is integrated into the trailer control valve 30 but may also be provided separately from the latter. The breakaway safety valve 22 is switched pneumatically and, for this purpose, has a breakaway safety valve control port 22.1. In the prior art, this is typically connected to the trailer brake pressure line 34 or to a pilot control path of the pilot control unit 35, with the result that, if the trailer feed line breaks away, that is, if the trailer feed port 32 is vented, the breakaway safety valve 22 is moved into the switching position that is not shown in FIG. 2, in which the supply port 31 of the trailer control valve 30 is connected to the trailer feed port 32 only via the restrictor 22.2 but not via a larger cross section, as in the spring-preloaded switching position shown in FIG. 2.

However, in the embodiment shown here (FIG. 2), the breakaway safety valve control port 22.1 is connected to the deactivation valve unit 24. In the embodiment shown in FIG. 2, the deactivation valve unit 24 is configured as a 3/2-way valve and has a first deactivation port 24.1, a second deactivation port 24.2 and a third deactivation port 24.3. When de-energized, the deactivation valve unit 24 is in the switching position shown in FIG. 2, in which the first deactivation port 24.1 is connected to the third deactivation port 24.3. The third deactivation port 24.3 is connected to a vent 7, and therefore the breakaway safety valve control port 22.1 is also vented. The breakaway safety valve 22 is consequently in the switching position shown in FIG. 2, in which delivery of supply pressure pV from the supply port 31 to the trailer feed port 32 is possible via the breakaway safety valve 22. If, on the other hand, the deactivation valve unit 24 is switched by the provision of the deactivation switching signal SD, the first deactivation port 24.1 is connected to the second deactivation port 24.2, which, for its part, is connected to the supply port 31. In this way, a breakaway control pressure pSA is output at the breakaway safety valve control port 22.1, which ensures that the breakaway safety valve 22 switches into the switching position that is not shown in FIG. 2, and therefore the supply port 31 and the trailer feed port 32 are separated or connected only via the restrictor 22.2. In this way, further delivery of supply pressure from the third compressed air supply 122 to the trailer 204 can be prevented.

As is apparent from FIG. 2, when the breakaway safety valve 22 is switched, the supply to the relay valve 36 is also simultaneously prevented or only possible via the restrictor 22.2, and therefore the trailer brake pressure pBA for actuating the service brake actuators 10a-10f of the trailer 204 also cannot be output. FIG. 3 shows a variant of the circuit from FIG. 2, in which the output of the trailer brake pressure pBA is not possible even when the breakaway safety valve 22 has switched. For this purpose, the relay valve 36 is connected to the supply port 31 of the trailer control valve 30 in such a way that the breakaway safety valve 22 is not connected between the two but the supply to the relay valve 36 is independent of the switching of the breakaway safety valve 22.

The advantage that the trailer brake pressure pBA can be output even when the breakaway safety valve 22 is in the switching position that is not shown in FIG. 3, consists, in particular, in that the service brake actuators 10a-10f of the trailer 204 can be actuated even when further delivery of compressed air to the trailer supply reservoir 8 is prevented. It is thereby possible to consume compressed air in the trailer 204 and allow the trailer supply reservoir 8 to run empty without filling the latter further from the motor vehicle.

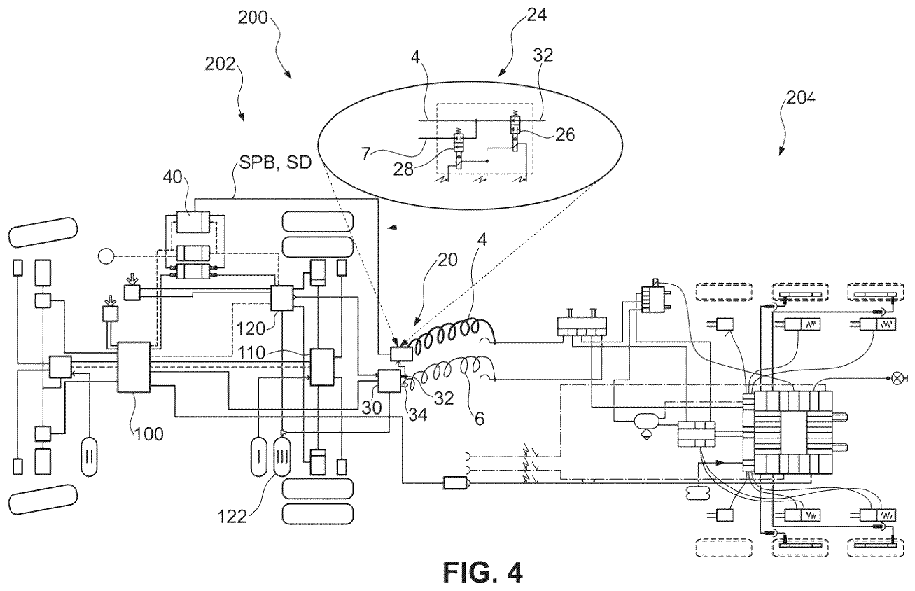

FIG. 4 shows a variant of the vehicle combination 200 in a second embodiment. Identical and similar elements are provided with identical reference signs and, to this extent, reference is made in full to the above description. It is especially the differences with respect to the first embodiment (FIG. 1) that are highlighted below. In the embodiment shown in FIG. 4, the valve assembly 20 once again includes a deactivation valve unit 24, which its connected pneumatically between the trailer feed port 32 and the trailer feed line 4. In particular, the deactivation valve unit 24 can be connected between the trailer feed port 32 and a red coupling head (not shown here), to which the trailer feed line 4 can then be coupled.

Here, the deactivation valve unit 24 includes a first 2/2-way valve 26 and a second 2/2-way valve 28, which are interconnected in such a way that the trailer feed port 32 can be shut off and the trailer feed line 4 or the red coupling head can be vented. In another embodiment, it is also possible for the first and second 2/2-way valves 26, 28 to be replaced by a single 3/2-way valve.

In contrast to the first embodiment (FIG. 1), the deactivation valve unit 24 is controlled immediately and directly by the unit for autonomous driving 40, which provides it with the deactivation switching signal SD. Alternatively, the deactivation valve unit 24 can also be switched by the primary brake control unit 100 and can be wired directly to the latter. It is furthermore conceivable that the unit for autonomous driving 40 provides the demand SPB to the primary brake control unit 100, and the latter then outputs the deactivation switching signal SD to the deactivation valve unit 24. Other variants are conceivable, it being conceivable, in particular, that each control unit which has its own intelligence, for example, the rear axle modulator 110, the parking brake module 120 or an electronic air treatment unit (not shown).

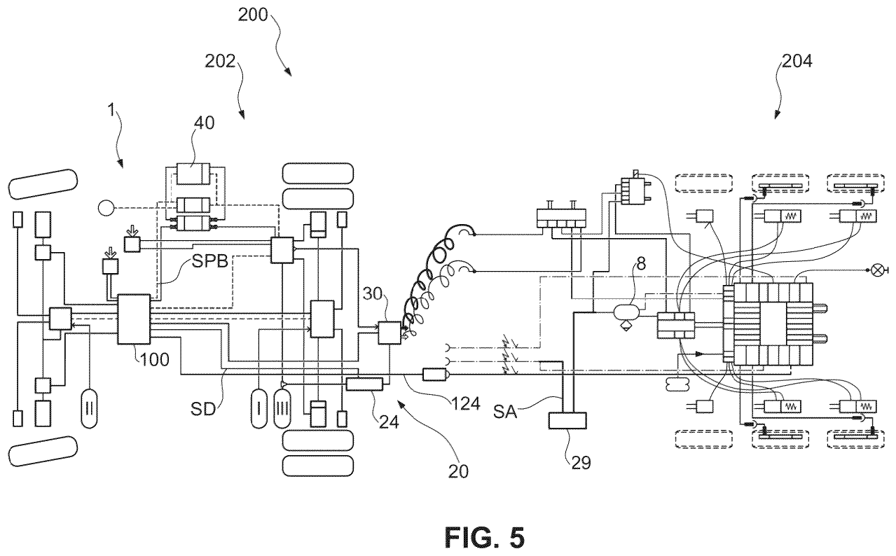

FIG. 5 shows a third embodiment of the vehicle train and, once again, identical and similar elements are denoted by identical reference signs to those in FIGS. 1 and 4. Once again, it is especially the differences that are highlighted below, while no further explanation is given of corresponding features.

In addition to the deactivation valve unit 24 shown in FIG. 1, the embodiment shown in FIG. 5 is provided with a trailer vent valve 29, which can directly vent the trailer supply reservoir 8. Via the trailer vent valve 29, the trailer supply reservoir 8 can be vented directly into the surroundings in order in this way to quickly lower the trailer supply pressure pVA. For this purpose, the trailer vent valve 29 can include one or more switching valves, for example, a 3/2-way valve or two 2/2-way valves, which can be controlled by a trailer switching signal SA in the embodiment shown here. The trailer switching signal SA is provided via the trailer BUS 124 by the motor vehicle 202, in particular by the motor vehicle braking system 1. More specifically, the trailer switching signal SA is output by the primary brake control unit 100, which outputs the signal in response to the receipt of the demand SPB for safe braking of the trailer 204.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 motor vehicle braking system
2 trailer braking system
3 trailer brake circuit
4 trailer feed line
6 trailer control line
8 trailer supply reservoir
20 valve assembly
22 breakaway safety valve
22.1 breakaway safety valve control port
22.2 restrictor
24 deactivation valve unit
24.1 first deactivation port
24.2 second deactivation port
24.3 third deactivation port
26 first 2/2-way valve
28 second 2/2-way valve
29 trailer vent valve
30 trailer control valve
31 supply port
32 trailer feed port
34 trailer brake pressure port
35 pilot control unit
36 relay valve
40 unit for autonomous driving
100 primary brake control unit
102 vehicle BUS
104 front axle brake circuit
106 rear axle brake circuit
108 first compressed air supply
110 rear axle modulator
112a, 112b first and second rear axle brake actuators
114 second compressed air supply
116 front axle modulator
118a, 118b first and second front axle brake actuators
120 parking brake module
121 parking brake system
122 third compressed air supply
123 internal BUS
124 trailer BUS
126 protection valve
128 park-release safety valve
130 trailer control unit
132 trailer parking brake module
200 vehicle combination
202 motor vehicle
204 trailer
pBHA rear axle brake pressure
pBVA front axle brake pressure
pV supply pressure
pVA trailer supply pressure
pSA breakaway control pressure
SA trailer switching signal
SBA braking demand signal
SBT trailer brake signals
SD deactivation switching signal
SVA front axle brake signal
SHA rear axle brake signal

1. A method for safely braking a trailer of a vehicle combination including a motor vehicle and the trailer, wherein the motor vehicle has an electronically controllable pneumatic motor vehicle braking system and the trailer has a pneumatic trailer braking system, wherein the motor vehicle braking system and the trailer braking system are connected at least by a trailer control line and a trailer feed line, and the trailer braking system has at least one trailer brake circuit having a trailer supply reservoir for making available a trailer supply pressure for the at least one trailer brake circuit, service brake actuators and spring brake actuators, the method comprising:
lowering the trailer brake pressure in the trailer brake circuit via the motor vehicle in response to a demand for safe braking of the trailer with a result that the spring actuators of the trailer are applied and safely brake the trailer.

2. The method of claim 1 further comprising preventing pressure output via the trailer feed line to prevent filling of the trailer supply reservoir.

3. The method of claim 2, wherein the trailer feed line is divided to prevent filling of the trailer supply reservoir.

4. The method of claim 2, wherein the motor vehicle braking system deactivates compressed air delivery via the trailer feed line.

5. The method of claim 2, wherein the motor vehicle braking system causes at least one valve assembly to at least one of switch, shut off, vent, and restrict the trailer feed line.

6. The method of claim 5, wherein the at least one valve assembly includes a breakaway safety valve of the motor vehicle braking system.

7. The method of claim 6, wherein the breakaway safety valve is pneumatically switchable, and the motor vehicle braking system outputs a breakaway control pressure at the breakaway safety valve such that the breakaway safety valve switches and prevents pressure output via the trailer feed line.

8. The method of claim 5, wherein the at least one valve assembly includes an electromagnetic deactivation valve unit configured to be controlled by the motor vehicle.

9. The method of claim 8, wherein the electromagnetic deactivation valve unit is connected pneumatically at least one of upstream and downstream of a trailer control valve of the motor vehicle braking system.

10. The method of claim 5, wherein the at least one valve assembly includes an electromagnetic trailer vent valve in the trailer braking system; and, the electromagnetic trailer vent valve is configured to be controlled by the motor vehicle.

11. The method of claim 1, wherein said lowering of the trailer supply pressure includes actuating the service brake actuators of the trailer braking system.

12. The method of claim 11, wherein the actuation of the service brake actuators takes place in a pulsed manner by alternate air admission to and venting of the service brake actuators.

13. The method of claim 1, wherein said lowering of the trailer supply pressure includes actuating a trailer parking brake.

14. The method of claim 1, wherein said lowering of the trailer supply pressure includes actuating an alternative air consumer in the trailer.

15. The method of claim 14, wherein the alternative air consumer is at least one of a level control system and a lift axle.

16. The method of claim 1, wherein the demand for safe braking is provided by at least one of a service brake system of the motor vehicle braking system, a parking brake system of the motor vehicle braking system, an electronic air treatment unit of the motor vehicle braking system, and a unit for autonomous driving of the motor vehicle.

17. The method of claim 1 further comprising driving the motor vehicle against the safely braked trailer to test a braking effect.

18. An electronically controllable pneumatic motor vehicle braking system for a motor vehicle of a vehicle combination, the electronically controllable pneumatic motor vehicle braking system comprising:
a service brake system having a trailer control valve with a trailer feed port for connecting a trailer feed line and a trailer brake pressure port for connecting a trailer control line, at least one trailer brake circuit on a motor vehicle side for supplying said trailer control valve with a supply pressure, wherein said trailer control valve is configured to make available a trailer supply pressure at said trailer feed port;
a primary brake control unit for controlling the service brake system, wherein said primary brake control unit is connected to a unit for autonomous driving and receives braking demand signals from the unit for autonomous driving; and,
wherein the electronically controllable pneumatic motor vehicle braking system is configured, in response to a demand for safe braking of a trailer connected to the motor vehicle, to bring about lowering of the trailer supply pressure, with a result that spring brake actuators of the trailer are applied and safely brake the trailer.

19. The electronically controllable pneumatic motor vehicle braking system of claim 18 further comprising at least one valve assembly for shutting off said trailer feed port.

20. The electronically controllable pneumatic motor vehicle braking system of claim 19, wherein said at least one valve assembly includes a breakaway safety valve.

21. The electronically controllable pneumatic motor vehicle braking system of claim 20 further comprising:
an electromagnetic trip valve unit;
said breakaway safety valve being pneumatically switchable; and,
said electromagnetic trip valve unit being configured to output a breakaway control pressure at said breakaway safety valve such that said breakaway safety valve switches and prevents pressure output via said trailer feed line.

22. The electronically controllable pneumatic motor vehicle braking system of claim 21, wherein said trip valve unit is integrated into said trailer control valve or is arranged adjacent to said trailer control valve.

23. The electronically controllable pneumatic motor vehicle braking system of claim 19, wherein said at least one valve assembly includes an electromagnetic deactivation valve unit configured to be controlled by the motor vehicle braking system.

24. The electronically controllable pneumatic motor vehicle braking system of claim 19, wherein said at least one valve assembly includes an electromagnetic deactivation valve unit configured to be controlled by said primary brake control unit.

25. The electronically controllable pneumatic motor vehicle braking system of claim 23, wherein said electromagnetic deactivation valve unit is connected pneumatically upstream and/or downstream of said trailer control valve.

26. The electronically controllable pneumatic motor vehicle braking system of claim 18, wherein, to lower the trailer supply pressure, a trailer brake pressure is output at said trailer brake pressure port of said trailer control valve.

27. A motor vehicle comprising:
an autonomous driving unit;
an electronically controllable pneumatic motor vehicle braking system including a service brake system and a primary brake control unit for controlling the service brake system;
said service brake system having a trailer control valve with a trailer feed port for connecting a trailer feed line and a trailer brake pressure port for connecting a trailer control line, at least one trailer brake circuit on a motor vehicle side for supplying said trailer control valve with a supply pressure, wherein said trailer control valve is configured to make available a trailer supply pressure at said trailer feed port;
said primary brake control unit being connected to a unit for autonomous driving and receives braking demand signals from said autonomous driving unit; and,
said electronically controllable pneumatic motor vehicle braking system being configured, in response to a demand for safe braking of a trailer connected to the motor vehicle, to bring about lowering of the trailer supply pressure, with a result that spring brake actuators of the trailer are applied and safely brake the trailer.

28. The motor vehicle of claim 27, wherein the motor vehicle is a commercial vehicle.
